(19) United States
(12) Patent Application Publication
(10) Pub. No.: US 2024/0127232 A1
(43) Pub. Date: Apr. 18, 2024

(54) SYSTEMS AND METHODS FOR IMPROVED ELECTRONIC TRANSFER OF RESOURCES VIA A BLOCKCHAIN

(71) Applicant: Centbee (Pty) Ltd., Sandton (ZA)

(72) Inventors: Angus James Farquharson Campbell BROWN, Johannesburg (ZA); Lorien Benjamin GAMAROFF, Johannesburg (ZA)

(21) Appl. No.: 17/769,314

(22) PCT Filed: Oct. 8, 2020
(86) PCT No.: PCT/IB2020/059477

§ 371 Date: Apr. 14, 2022

(30) Foreign Application Priority Data
Oct. 16, 2019 (GB) 1914950.9

(51) Int. Cl. G06Q 20/38; G06F 21/64; G06Q 20/02; H04L 9/32

(52) U.S. Cl. CPC G06Q 20/3829; G06F 21/64; G06Q 20/02; H04L 9/3234; H04L 9/3247

(57) ABSTRACT

The present disclosure provides methods and systems for performing a transfer of at least one resource across a computer-implemented network from a user's non-custodial digital wallet to a recipient. The disclosure provides solves technical challenges to provide a novel infrastructure and network architecture for enabling a transfer between a user (e.g. customer) and a recipient (e.g. merchant) involving the use of non-custodial digital wallets to effect transfer via a blockchain. The disclosure also provides an enhanced security and verification/authentication solution because it uses cryptographic techniques to implement the solution on a blockchain (e.g a variation of the Bitcoin protocol or other protocols) whilst reducing the resources required by known arrangements for native cryptocurrency transfers from a digital wallet at a location of a recipient's device e.g. an electronic Point of Sale (PoS), IoT device etc.

### FIELD

This disclosure relates generally to methods and systems for conducting secure and transfers over an electronic network, and more particularly to the use of blockchain technologies for secure transfers of electronic assets including, but not limited to, tokens and cryptocurrency. The invention is particularly suited for advantageous use in respect of efficient transfers made using a digital wallet such as, for example, a non-custodial wallet. It is also advantageous in situations or locations where electronic communication connectivity is unreliable or unavailable.

### BACKGROUND

In this document we use the term ‘blockchain’ to include all forms of electronic, computer-based, distributed ledgers. These include consensus-based blockchain and transaction-chain technologies, permissioned and un-permissioned ledgers, shared ledgers, public and private blockchains, and variations thereof. The most widely known application of blockchain technology is the Bitcoin ledger, although other blockchain implementations have been proposed and developed. While Bitcoin may be referred to herein for the purpose of convenience and illustration, it should be noted that the disclosure is not limited to use with the Bitcoin blockchain and alternative blockchain implementations and protocols fall within the scope of the present disclosure. The term “user” may refer herein to a human or a processor-based resource. The term “Bitcoin” is used herein to include any version or variation that derives from or is based on the Bitcoin protocol.

A blockchain is a peer-to-peer, electronic ledger which is implemented as a computer-based decentralised, distributed system made up of blocks which in turn are made up of transactions. Each transaction is a data structure that encodes the transfer of control of a digital asset between participants in the blockchain system, and includes at least one input and at least one output. Each block contains a hash of the previous block to that blocks become chained together to create a permanent, unalterable record of all transactions which have been written to the blockchain since its inception. Transactions contain small programs known as scripts embedded into their inputs and outputs, which specify how and by whom the outputs of the transactions can be accessed. On the Bitcoin platform, these scripts are written using a stack-based scripting language.

In order for a transaction to be written to the blockchain, it must be “validated”. Network nodes (miners) perform work to ensure that each transaction is valid, with invalid transactions rejected from the network. Software clients installed on the nodes perform this validation work on an unspent transaction (UTXO) by executing its locking and unlocking scripts. If execution of the locking and unlocking scripts evaluate to TRUE, the transaction is valid and the transaction is written to the blockchain. Thus, in order for a transaction to be written to the blockchain, it must be i) validated by the first node that receives the transaction—if the transaction is validated, the node relays it to the other nodes in the network; and ii) added to a new block built by a miner; and iii) mined, i.e. added to the public ledger of past transactions.

Once stored in the blockchain as a UTXO, a user can transfer control of the associated resource to another address associated with an input in another transaction. This is often done using a cryptocurrency wallet. This digital wallet may be or comprise a device, physical medium, program, application (app) on a mobile terminal, or a remotely hosted service associated with a domain on a network work, such as the Internet. The digital wallet stores public and private keys and can be used to track ownership of resources, tokens and assets etc. associated with a user, receive or spend cryptocurrencies, transfer tokens which may relate to cryptocurrencies or other types of resource.

Blockchain-implemented transfers require the transaction to be signed by the holder of the private key before creation of the transaction. Only once this is done can the transaction be submitted to the blockchain network for validation. Hence, transfers that involve cryptocurrency are intrinsically ‘credit push’ in nature. The signing of a blockchain transaction is typically performed via software that manages the private keys. This software is typically a desktop or mobile application. The wallet (and therefore private key) is normally managed by the user themselves (non-custodial) or on behalf of the user by a service provider (custodial).

Sometimes, it is necessary or desired to make a blockchain-implemented transfer at a particular geographical location and/or using electronic apparatus that is provided at a physical location. This includes but is not limited to, for example, transfers made at a physical point-of-sale (POS), an ATM, a vending or ticketing machine, a blockchain-enabled authorisation device or a blockchain IoT device, a voting terminal, or any kind of apparatus that needs to be able to “spend” a UTXO. However, when a blockchain transfer needs to be made between parties/devices at a particular location, this gives rise to certain technical challenges.

For example, desktop-only wallets cannot be used with all forms of location-dependent apparatus e.g. when a user wishes to transfer funds stored in a wallet on a desktop device to a taxi driver's POS. On the other hand, if we consider the more transportable nature of mobile wallets that are used, for example, on phones or tablets, users still need to authorise payments from their wallet. Thus the user will need to be online or somehow able to communicate with other parties to authorise the transfer. This means that transfers (e.g. payments, tokenised asset exchanges, data sharing etc) cannot be completed in certain situations, e.g. using a crypto payment at a POS that is underground such as at tube/subway stations, taxis or bars etc., or in an area with poor or no signal coverage. Thus, there is a technical, connectivity-related problem of how to conduct a transfer over a blockchain when the sender's device/software is unable to communicate or interact with the recipient or other relevant parties.

Additionally, in an illustrative use-case concerning cryptocurrency payments, the existing payment infrastructure operates in a way where card payments can be considered as ‘pull’ payments, where data is pulled from a card to the issuer via the acquiring bank and the card scheme. The act of presenting the card at a POS, either as a contactless payment or using chip & PIN verification, acts as the authorisation of a payment. That process does not currently allow for customers to ‘push’ payments. Again, a technical challenge arises because the architecture and configuration of existing systems are simply not designed to operate in a manner which is conducive to pushing authorisation/data from the sender to another party. In fact, they operate such that transactions and data flow in a direction opposite to the intrinsic nature of blockchain transfers, as mentioned above.

While there are methods and processes that exist which allow for crypto payments at a POS, each of them has significant technical disadvantages compared to embodiments described herein. The two main alternatives are:

Custodial Wallets
these provide the ability to make a payment at a POS using a Visa/MasterCard e.g. Coinbase Card
The custodial wallet service provider acts as an Issuer in the traditional 4-party model, issuing a card, providing a crypto balance that can be used in a payment, and handling the conversion of crypto into fiat currency for future settlement
The custodial wallet service provider is responsible for securing the private keys, resulting in the user having to trust the custodial wallet service provider to secure their funds against compromise, both from internal and external actors;
exploits such as the Mt. Gox hack have been known (https://en.wikipedia.org/wiki/Mt._Gox) in which private keys have been accessed, enabling theft of assets. Thus, there is a security challenge arising from the use of custodial wallets which renders them unsuitable for situations where the user/cryptocurrency owner needs to be assured of a high degree of protection.

Pre-Paid Card Schemes
these require the user to load a pre-paid card prior to making the transfer
However, these do not provide a true native cryptocurrency payment at POS
The fiat to cryptocurrency conversion is based on the date/time of the initial load onto the card. If the crypto/fiat exchange rate has changed since the load took place, the customer cannot take advantage of any favourable changes in rates
Likewise, the available crypto balance is locked as fiat, reducing the availability of the user's cryptocurrency for other purposes. Thus, there is a technical challenge arising from an inability to guarantee availability of functionality and resources.

Although there are processes that exist where the user does not control the private key, but can still make blockchain-implemented transfers at the location-dependent recipient device e.g. POS, the presence of the private key is essential to the cryptocurrency model and that private key must not be compromised or shared without authorisation in order to retain the security and privacy of the assets held in that address. Sharing and communication of the private key by any electronic means opens vulnerabilities to detection, storage and unauthorised use.

Hence a solution is desired that allows, amongst other things, for blockchain-implemented transfers/transactions to be created and signed without the user using the private key at that moment of exchange. This solution must also preserve or enhance the security of that private key to prevent unauthorised usage. It must also overcome or at least alleviate challenges relating to device connectivity and device interoperability. It should address issues relating to the availability of blockchain-implemented assets when required by a user, and also lend itself to being operable in a wide variety of situations including those were a transfer needs to be made at a particular location.

The desired solution should not require the owner of the cryptocurrency address to cede sole authority of that address to another party, to enhance or preserve security and avoid unauthorised access or theft. The user should still be able to access their assets using their existing authentication mechanism (e.g. password/PIN verification) using a desktop or mobile App. This provides the advantage of a user-friendly security/authorisation solution which users are familiar with, and thus provides ease of use.

It is also preferable that the user does not have to move their resources to a new cryptocurrency address to benefit from this solution. This allows for a more efficient solution in terms of required resources, and a faster transfer process overall.

The solution should also be designed to ensure that the participants who sign the transaction do not have financial or other incentives to collude to fraudulent access of the user's funds, or at least have economic or other incentives to protect the security of the user's private key.

In accordance with an advantageous and illustrative use case, the present disclosure provides a process and system in which it is possible to use cryptocurrency to pay for goods & services at a point-of-sale using a non-custodial wallet solution without the need for any additional authorisation steps beyond those normally associated with a card payment.

Thus, an efficient and secure alternative is provided which addresses at least the above-mentioned technical challenges, and enables an electronic transfer of blockchain-based assets (e.g. tokenised assets and/or cryptocurrency) in a manner which is technically different from existing infrastructures and processes.

Use-Cases and Applications:

Examples and use cases may be provided herein which relate or refer to financial transactions and payments. This is for ease of illustration only because such examples are readily known and understood. However, it is important to note that embodiments of the disclosure are not limited to use in respect of such illustrative contexts. Blockchain transactions can be used for a variety of purposes, not simply for cryptocurrency purchases for goods/services. When a blockchain transaction is added to a ledger, control of a portion of cryptocurrency is transferred from one party to another. This is the underlying mechanism by which blockchain transactions are formed and utilised in accordance with a corresponding protocol (e.g. Bitcoin). However, the primary purpose of a blockchain transaction may be to perform other types of transfers and functionalities, such as sharing data or tokenised assets or payloads of different types, forms and nature. Embodiments of the present disclosure can be employed to advantage in any situation where a blockchain-enabled transfer needs to be performed for some end-use reason or application. For example, when controlling access to an IoT device such as a vehicle, or transferring a tokenised asset (including a physical, digital or virtual asset) via a blockchain transaction.

### Terminology

The term “user” may be used herein to refer to a human user, an organisation or a device/system. It may also comprise the term “sender” in that the user may transfer/spend a portion of cryptocurrency from a UTXO to a designated recipient. “Recipient” may comprise a human, an organisation or a device/system.

The term “recipient device” may be used herein to refer to a device/system which is associated with a recipient. This may be, for example, a Point-of-Sale (PoS) device, a terminal or some other processor-based device for receiving electronic data from one or more users. The recipient device is associated with the recipient.

A “transfer facilitator” may be referred to as a “wallet provider” and/or “transfer processor”. Additionally or alternatively, it may be referred to as a “wallet provider and/or payment processor”.

The term “security device” may, alternatively, be referred to as a security device, or an authorisation device, transfer device, and/or payment device. The security device can be used to initiate and/or perform a transfer from a sender to a recipient, and/or verify the user's identity. It may comprise a smart card such as, for example, a payment card and in such cases the device provider may be referred to as a card provider. The card provider may issue a card in association with an issuing bank and marked with one of the pre-existing card schemes (e.g. Visa, MasterCard etc.). The card may comprise the functionality and components of payment cards known in the art and currently issued by commercial banks, e.g. an Integrated Circuit payment card comprising contactless and chip & PIN capabilities.

In other embodiments, however, the card may not be a payment industry card but may be some type of smart card or other device/hardware token/electronic component issued by a security device provider and by which the user can initiate and/or verify a transfer to a recipient. For example, it may comprise a key fob for gaining access to a vehicle, or a biometric data reader/authenticator etc.

The term “acquirer” may be used herein to refer to an entity which processes transfers from a user to a recipient on behalf of another entity e.g. the recipient or an organisation associated with the recipient.

### SUMMARY

An illustrative embodiment provided in accordance with the present disclosure may be summarised as follows.

The user has, and maintains full control over, a mobile wallet; this wallet comprises the functionality and components of a mobile wallet known in the art and operative to store and transfer cryptocurrency assets, generate blockchain transactions etc. The mobile wallet is a non-custodial wallet in that control and storage of the private keys is retained by the user's wallet rather than by a wallet/service provider.
A relationship may exist between the user and an entity which provides a security device which can be used to authorise/generate a transfer from the user to a recipient. A novel entity, the transfer facilitator, may be provided and may facilitate (at least) the ability to manage the relationship between the security device and the user's wallet; additionally or alternatively, the transfer facilitator may facilitate, enable or provide the conversion of cryptocurrency to a preferred or designated recipient currency (for example, fiat currency); the recipient currency may, in some embodiments, be referred to as a settlement currency. The transfer facilitator may generate or provide the user's wallet.

To reduce the need for additional authorisation steps, the private key (“secret”) securing the user's wallet is split into multiple parts, with parts of the secret distributed to:
The user wallet
The transfer facilitator (e.g. wallet provider & payment processor)
The security device (e.g. card) provider

Thus, each of the three participants has a share, but not the full secret. No single participant is able to use their share to gain access to the secured resource(s). This provides security and also enables a system which avoids placing all authority or trust into one party.

When the user wishes to perform a transfer from the wallet, authorisation is performed based on the presence of 2 of the 3 shares of the secret. The method of splitting the secret and recombining these can be achieved using any suitable known technique, such as that described in WO2017/145010 (International patent application PCT/IB2017/050829).

The third share provides an element of redundancy within this process. This is important for the non-card based operation of the wallet.

### BRIEF DESCRIPTION OF THE DRAWINGS

Aspects and embodiments of the present disclosure will now be described, by way of example only, and with reference to the accompany drawings, in which:

FIG. 1 is an overview of an illustrative embodiment formed in accordance with the present disclosure.

FIG. 2 is a schematic diagram illustrates a computing environment in which various embodiments can be implemented.

### DETAILED DESCRIPTION

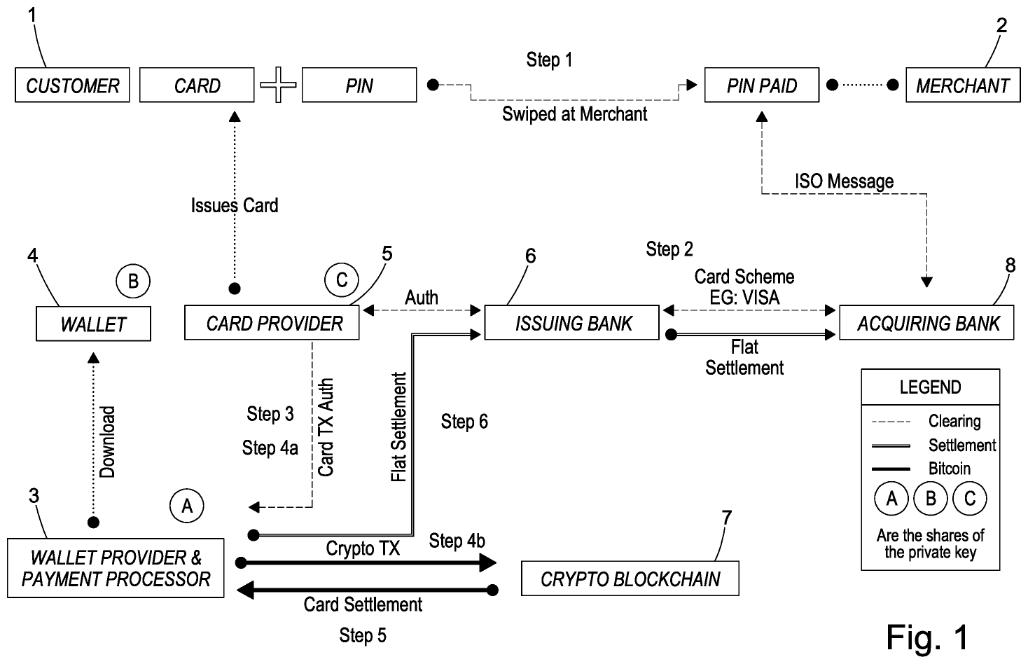

In accordance with an illustrative embodiment of the present disclosure, and with reference to FIG. 1, there is provided a simple, efficient and secure method of performing a transfer of a resource or asset, such as a portion of funds, from a user's wallet to a recipient across a network and associated infrastructure. Certain embodiments of the disclosure comprise the use of at least three participants to the electronic exchange or transfer of the resource which is conducted over a computer-implemented network. Each of the participants is an entity on the network and are configured for communication between each other.

Each participant is provided with a share of a secret (e.g. private cryptographic key associated with a corresponding public key) which can be used to control access to a controlled resource. In one example the controlled resource is a non-custodial digital/cryptocurrency wallet. It is non-custodial in that the private keys for accessing the wallet or its resources are stored in association with the wallet rather than a provider or third party. Therefore, the user maintains control of their own private key(s). In one or more embodiments, the wallet is provided by the transfer facilitator.

The secret may be split into parts known as “shares” using any suitable threshold scheme such as Shamir's Secret Sharing Scheme (known as “4S”) and may be distributed securely to the participants in any suitable but secure manner, such as that disclosed in WO2017/145010 and/or WO2017145016. The secret may be reconstructed from a minimum number of shares, known as the “threshold”. In the illustrative embodiment described below, the secret is split into three shares which are distributed between a transfer facilitator (share (A) and entity (3), the wallet provider & payment processor, in FIG. 1), the user's wallet (share (B) and entity (4) in FIG. 1) and a security device provider (share (C) and entity (5), the card provider in FIG. 1).

In one illustrative embodiment of the disclosure, the secret key can be reconstructed from any two of the three shares, but no single share is sufficient on its own to serve as the key and provide signing functionality. Thus, security is maintained even if one of the participants' shares is compromised by a malicious third party. This prevents attacks such as the Mt. Gox attack which may target one of the participants. In addition, no single one of the participants is able to act on their own to complete the blockchain transaction which will perform the transfer, but needs the cooperation of another participant. Therefore, no single party acts as a trusted, controlling entity which again enhances the security and integrity of the transfer process compared with existing approaches.

In the following “in use” example, the user 1 may be referred to as a “customer” and the recipient 2 as a “merchant” for illustrative purposes only. It should be noted that we provide the example use case herein of a customer making a purchase from a merchant because such scenarios are familiar and readily understood but, as explained above, the disclosure is not limited to use in such contexts or solely in retail/commercially-oriented applications.

Step 1:

Suppose that a user 1 wishes to make a transfer to a recipient 2. In this example, the transfer is for payment for goods or services supplied by the recipient.

On presenting a payment card at a POS associated with the merchant 2, the customer 1 initiates an authentication session for the payment by either by tapping their card on the POS or using chip & PIN. Neither the POS supplier (normally an acquirer 8) nor the customer 1 needs to use a cryptocurrency wallet at this point. The customer 1 does not need to have their phone active or online. Again, this presents a technical improvement over the known arrangements which require connectivity between the user device and at least one other device, network or system.

Step 2:

The acquirer 8 sends the authorisation message, containing the digital signature of the customer 1, settlement currency and the payment value, to the card provider 5 via the card scheme and issuing bank 6 for authorisation.

Step 3: On successful validation of the customer's digital signature, the card provider 5 will provide their part of the secret to the wallet provider & payment processor 3.

Step 4: The wallet provider & payment processor 3 will check that the customer has sufficient balance in their wallet 4 to complete the payment. At this point, two processes are initiated:

Step 4a:
The first process, an authorisation message is passed to the card provider 5 to confirm the customer 1 has sufficient balance to complete the payment. This authorisation message is then passed back to the POS via the issuing bank 6, card scheme and acquirer 8 to inform the customer 1 and merchant 2 that the payment has been successful. Where insufficient funds exist, the authorisation message that is passed from the wallet provider & payment processor 3 will be a decline message.

Step 4b:
The second, the wallet provider & payment processor 3 creates a blockchain transaction (TX₁) to be submitted to the blockchain 7. This message is created to complete the payment transfer from customer 1 to merchant 2. The wallet provider & payment processor 3 adds their share of the secret (A) to the one supplied by the card provider (C) to construct the required secret for the wallet (i.e. the private key) and uses this to sign the transaction.

Step 5:
If the settlement currency is the native cryptocurrency (i.e. the cryptocurrency recognised and defined by the blockchain's underlying protocol), the transaction (TX 1) will simply spend the transaction amount from the customer wallet 4 to the merchant wallet. If the settlement currency is a fiat currency, the wallet provider & payment processor 3 can provide services including, but not limited to, providing the cryptocurrency to fiat conversion, and providing the fiat settlement amount to the card provider 5.

Step 6:
As per conventional payment processes known in the art, the card provider 5 settles the fiat payment, minus fees, to the merchant 2 via the issuing bank 6, card scheme and acquirer 8.

By utilising an embodiment of the present disclosure, the user can perform a native cryptocurrency transfer at a recipient device e.g. POS without having to provide additional authorisation as is normally required when making a cryptocurrency transfer, and even when conventionally required network resources e.g. mobile signal coverage are not available. Thus, embodiments of the disclosure provide a more efficient and technically robust solution than known blockchain-implemented transfer techniques because fewer resources and less time are required to complete the process. Fewer authentication steps result in a secure yet simplified solution which the user finds easy to use. Thus, several technical benefits are provided as solutions to technical problems, including but limited to those described herein.

Other benefits of the disclosure include, but are not limited to the following advantages:
No single entity can compromise the customer's resource(s), protecting the customer from hacks that either the security device provider or transfer facilitator may be vulnerable to.
The solution allows for a user to use funds or resources that they are in complete control of when making a transfer via a recipient device. This shifts the control to the user, providing an arrangement which operates in a manner which is diametrically opposed to known solutions.
In some embodiments, the solution leverages existing card payment infrastructure to provide the security, convenience and acceptance of cryptocurrency at POS terminals. No specialist or proprietary hardware or platform is required.
The user does not need access to their cryptocurrency wallet 4 at point of transfer, meaning the user can be underground or in poor signal areas when making a transfer. A more versatile and technically capable solution is thus provided.
The security device provider does not need to interact with cryptocurrency wallets or networks, nor do they need to keep track of user balances, thereby reducing the (e.g. regulatory) burden on security device providers.
Recipients are protected from the volatility of the underlying cryptocurrency by choosing to settle in another e.g. fiat currency.
The distribution of the secret into (a minimum of) three parts, where only two parts are required to authorise a transfer, provides the user with the ability to access their funds in the event of a share being lost. This provides a more useful, safe and secure solution for the user.
The user is not required to convert their cryptocurrency balance to fiat prior to a transfer (e.g. purchase), thereby ensuring full access to their cryptocurrency resources.
The transfer facilitator can use the blockchain to ensure transfer from the user's wallet has been made, and has not been double-spent. Again, this provides improved security in that it avoids fraudulent transfers.

Embodiments of the present disclosure may provide one or more of the following features described in the clauses provided below. Features described in relation to the method may also be applicable to the corresponding system and vice versa. Features recited in accordance with one aspect of the disclosure may be relevant to one or more other aspects of the disclosure, without explicit recitation as such.

There may be provided:

A computer-implemented method for performing a transfer of at least one resource across a network from a user's non-custodial (digital) wallet to a recipient. The resource(s) may comprise a portion of data, a portion of data relating to a transfer of currency and/or a payment, a transfer of, and/or control of, a portion of cryptocurrency.

The method may comprise the steps:
receiving a first share (C) of a private key from a first network entity (5) by a second network entity (3) which has access to a second share (A) of the private key; using the first and second shares (C, A) to generate a private key;
creating, at the second network entity, a blockchain transaction (TX₁) for performing the transfer from the user's wallet (4) to the recipient (2) based on transfer-related data and signed using the private key;
and
submitting the transaction to a blockchain network (7).

The private key may be generated by reconstructing it from the first and second shares to provide a complete private key. The wallet (4) may be associated with the user (1) and may be generated and/or provided by the transfer facilitator (3).

The method may comprise the step:
using the first network entity (5), to:
receive a digital signature associated with the user (1) and transfer-related data; and
verify the digital signature; (this may comprise the same transfer-related data as above, in part or entirety);
and
if verification is successful, providing the first share (C) of the private key to the second network entity (3). Verification may comprise comparing the digital signature against a known copy of the signature or a trusted calculation of the signature. The trusted calculation/generation of the signature may be provided using a cryptographic key.

The method may comprise the step of storing a third share (B) of the private key at, on or in association with the user's wallet. The user's wallet may be a mobile wallet. Preferably, it is a non-custodial wallet. It may comprise means for storing/second/receiving or otherwise processing cryptocurrency.

The method may comprise the step of splitting the private key into a plurality of shares and distributing at least one share to at least one of the user's wallet (4), the first network entity (5) and/or the second network entity (3).

The method may comprise the step of:
in response to a security device e.g. a payment card being presented at a device associated with a recipient (which may be referred to as a “recipient device”, e.g. an electronic Point-of-Sale device), generating a transfer request which requests the transfer from a user's non-custodial wallet to a recipient and includes the transfer-related data;
sending the transfer request from the recipient device to a third network entity (8).

The security device may be or comprise a smart card, a payment card, a hardware token, a biometric data reader, a wireless or contactless data component such as Bluetooth or NFC, and/or one or more hardware and/or software components for facilitating verification of a user's identity.

The recipient device may be or comprise an electronic point-of-sale (PoS) device, a terminal, laptop, mobile device and/or processor-based device.

The method may comprise the step of: receiving the transfer request at the third network entity;
generating an authorisation message comprising at least the digital signature associated with the user and the transfer-related data, and providing the authorisation to the first network entity.

The first network entity may be a security device provider (e.g. a payment card provider (5)); the security device provider may be a manufacturer or supplier of a security device as referred to herein;
the second network entity may be a wallet provider (3) which may also be referred to as a “transfer facilitator”; and/or the third network entity may be an acquirer (8).

The transfer related data may comprise one or more of: a currency indicator, a value or quantity relating to the resource and/or data relating to an account or a payment card associated with the user. Additionally or alternatively, it may comprise metadata or information relating to the transfer, the user, the security device, the recipient's device and/or the recipient. The metadata may be stored or provided in a script of a blockchain transaction.

The method may comprise the step of: determining whether or not the user's non-custodial wallet is able to complete the transfer of the resource to the recipient.

The method may comprise the step of: sending a transfer authorisation message from the second network entity to the first network entity and/or recipient device if it is determined that the user's non-custodial wallet is able to complete the transfer of the resource to the recipient;
Or:
sending a transfer decline message from the second network entity to the first network entity, third network entity and/or recipient device if it is determined that the user's non-custodial wallet is not able to complete the transfer of the resource to the recipient.

The step of using the first and second shares (C, A) to generate a private key may be performed by the second network entity. The blockchain transaction (TX₁) may comprise an output arranged to perform the transfer of the resource from the user's wallet to the recipient, and wherein the resource is a portion of cryptocurrency.

The method may comprise the step of: converting a portion of a first currency to a portion of a second currency and providing the portion of the second currency to the first network entity.

It may comprise the step of: transferring the resource from the first network entity to the recipient.

The user's non-custodial wallet may be a digital wallet arranged to store cryptocurrency; and/or may be provided by, in communication with and/or associated with the second network entity.

Embodiments of the disclosure may provide a system, comprising:
a processor; and
memory including executable instructions that, as a result of execution by the processor, causes the system to perform the method of any of the preceding clauses.

The system may comprise:
A recipient device such as an electronic Point-of-Sale device, a terminal or some other processor-based apparatus associated with the recipient;
a computer-implemented network of nodes arranged for communication with each other, and comprising nodes associated with the first, second and third network entities;
a non-custodial digital wallet associated with the user;
a security device such as a payment card, hardware token or smart card or identity verification apparatus associated with the user and provided by the first network entity.

Embodiments of the disclosure may also provide: a non-transitory computer-readable storage medium having stored thereon executable instructions that, as a result of being executed by a processor of a computer system, cause the computer system to perform the computer-implemented method according to any embodiment described or claimed herein.

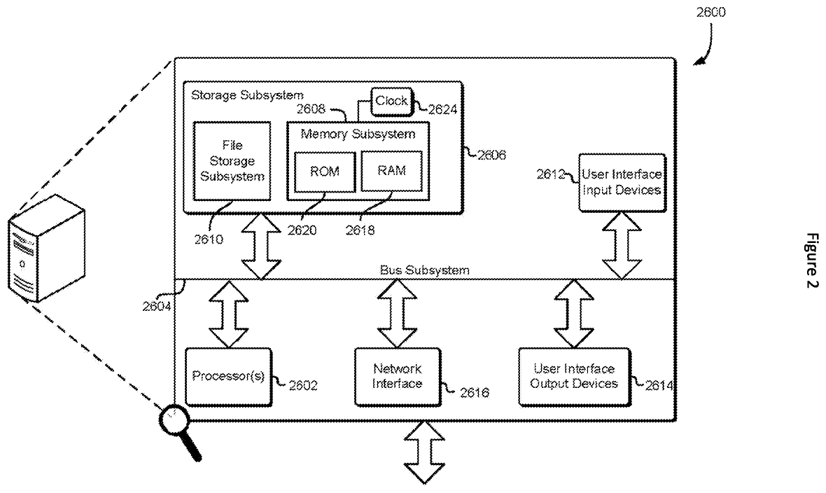

Turning now to FIG. 2, there is provided an illustrative, simplified block diagram of a computing device 2600 that may be used to practice at least one embodiment of the present disclosure. In various embodiments, the computing device 2600 may be used to implement any of the systems illustrated and described above. For example, the computing device 2600 may be configured for use as a web server or one or more processors or computing devices associated with a payment service or a payment client entity, i.e. to implement a host responsible for provision of the payment service, or to implement a payer or payee payment client entity. Thus, computing device 2600 may be a portable computing device, a personal computer, or any electronic computing device. As shown in FIG. 2, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.

A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilize multiple busses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 2 is intended only as a specific example for purposes of illustrating the preferred embodiment of the device. Many other configurations having more or fewer components than the system depicted in FIG. 2 are possible.

Throughout this specification the word “comprise”, or variations such as “includes”, “comprises” or “comprising”, will be understood to imply the inclusion of a stated element, integer or step, or group of elements, integers or steps, but not the exclusion of any other element, integer or step, or group of elements, integers or steps.

It should be noted that the above-mentioned embodiments illustrate rather than limit the disclosure, and that those skilled in the art will be capable of designing many alternative embodiments without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented method for performing a transfer of at least one resource across a network from a user's non-custodial wallet to a recipient, comprising the steps:
receiving a first share of a private key from a first network entity by a second network entity which has access to a second share of the private key;
using the first and second shares to generate a private key;
creating, at the second network entity, a blockchain transaction (TX₁) for performing the transfer from the user's wallet to the recipient based on transfer-related data and signed using the private key; and
submitting the transaction to a blockchain network.

2. The method according to claim 1, and further comprising the step:
using the first network entity, to:
receive a digital signature associated with the user and transfer-related data; and
verify the digital signature; and
if verification is successful, providing the first share of the private key to the second network entity.

3. The method according to claim 1, and further comprising the step of:
storing a third share of the private key at, on or in association with, the user's wallet.

4. The method according to claim 1, and further comprising the step of:
splitting the private key into a plurality of shares and distributing at least one share to at least one of the user's wallet, the first network entity and/or the second network entity.

5. The method according to claim 1, and further comprising the step of:
in response to a security device being presented at a recipient device, generating a transfer request which requests the transfer from a user's non-custodial wallet to a recipient and includes the transfer-related data; and
sending the transfer request from the recipient device to a third network entity.

6. The method according to claim 5, and further comprising the step of:
receiving the transfer request at the third network entity; and
generating an authorisation message comprising at least a digital signature associated with the user and the transfer-related data and providing the authorisation to the first network entity.

7. The method according to claim 5, wherein:
the security device is or comprises:
a smart card, a payment card, a hardware token, a biometric data reader, a wireless or contactless data component such as Bluetooth or NFC, one or more hardware and/or software components for facilitating verification of a user's identity; and/or
the recipient device is or comprises an electronic point-of-sale (PoS) device, a terminal, laptop, mobile device and/or processor-based device; and/or
the first network entity is a security device provider; and/or
the second network entity is a wallet provider; and/or
the third network entity is an acquirer.

8. The method according to claim 1, wherein the transfer related data comprises one or more of: a currency indicator, a value or quantity relating to the resource and/or data relating to an account or a security device associated with the user.

9. The method according to claim 1, and further comprising the step of:
determining whether or not the user's non-custodial wallet is able to complete the transfer of the resource to the recipient.

10. The method according to claim 9, and further comprising the step of:
sending a transfer authorisation message from the second network entity to the first network entity and/or recipient device if it is determined that the user's non-custodial wallet is able to complete the transfer of the resource to the recipient; or
sending a transfer decline message from the second network entity to the first network entity, third network entity, and/or recipient device if it is determined that the user's non-custodial wallet is not able to complete the transfer of the resource to the recipient.

11. The method according to claim 1, wherein:
the step of using the first and second shares to generate a private key is performed by the second network entity.

12. The method according to claim 1, wherein:
the blockchain transaction (TX₁) comprises an output arranged to perform the transfer of the at least one resource from the user's wallet to the recipient, and wherein the resource is or comprises a portion of cryptocurrency.

13. The method according to claim 1, and further comprising the step of:
converting a portion of a first currency to a portion of a second currency and providing the portion of the second currency to the first network entity.

14. The method according to claim 1, and further comprising the step of:
transferring the resource from the first network entity to the recipient.

15. The method according to claim 1, wherein the user's non-custodial wallet:
is a digital wallet arranged to store cryptocurrency; and/or
is provided by, in communication with and/or associated with the second network entity.

16. A system, comprising:
a processor; and
memory including executable instructions that, as a result of execution by the processor, cause the system to perform the method of claim 1.

17. The system according to claim 16, and further comprising:
an electronic recipient device associated with the recipient;
a computer-implemented network of nodes arranged for communication with each other, and comprising nodes associated with the first, second, and third network entities;
a non-custodial digital wallet associated with the user; and
a security device associated with the user and provided by the first network entity.

18. A non-transitory computer-readable storage medium having stored thereon executable instructions that, as a result of being executed by a processor of a computer system, cause the computer system to perform the computer-implemented method of claim 1.

19. A system, comprising:
a processor; and
memory including executable instructions that, as a result of execution by the processor, cause the system to perform the method of claim 2.

20. A non-transitory computer-readable storage medium having stored thereon executable instructions that, as a result of being executed by a processor of a computer system, cause the computer system to perform the computer-implemented method of claim 2.
